(19) United States
(12) Patent Application Publication
(10) Pub. No.: US 2016/0253611 A1
(43) Pub. Date: Sep. 1, 2016

(54) COMPONENT-SHELF-LAYOUT DESIGN DEVICE AND PROGRAM

(71) Applicant: HITACHI, LTD., Chiyoda-ku, Tokyo (JP)

(72) Inventor: Satoshi NAGAHARA, Tokyo (JP)

(73) Assignee: HITACHI, LTD., Tokyo (JP)

(21) Appl. No.: 15/029,793

(22) PCT Filed: Oct. 3, 2014
(86) PCT No.: PCT/JP2014/076490

§ 371 Date: Apr. 15, 2016

(30) Foreign Application Priority Data
Oct. 16, 2013 (JP) 2013-215163

(51) Int. Cl. G06Q 10/06; G06Q 10/08

(52) U.S. Cl. CPC G06Q 10/06313; G06Q 10/087

(57) ABSTRACT

On the basis of picking-operation-results information for each component, component-shelf-interval-distance information, and component-shelf-layout information, which is all stored in a storage unit, this component-shelf-layout design device calculates picking-movement distance and replacement-occurrence frequency and extracts an optimal component-shelf layout proposal from among the current component-shelf layout and a plurality of newly generated component-shelf layout proposals. Said configuration makes it possible to design a component-shelf layout proposal which makes it possible to efficiently execute a component-shelf picking operation and a component-shelf replacement operation in a production/distribution facility.

### TECHNICAL FIELD

The present invention relates to a layout design of component shelves in warehouse in a production/distribution facility.

### BACKGROUND ART

A typical example of an operation for delivering a desired component from warehouse is a picking operation. A form of the picking operation is a method in which an operator collects a specified component while moving around component shelves. For performing the picking operation efficiently in this method, it is important to optimize the arrangement of the component shelves in a picking area. Determination of the component-shelf arrangement described above is called component-shelf-layout design.

An example of a conventional method of the component-shelf-layout design that aims to improve the efficiency of the picking operation is a method described in Patent Literature 1 in which the arrangement of the component shelves is determined in accordance with a delivery frequency of each component. According to Patent Literature 1, an instruction to change a layout is issued in such a manner that a component having a high delivery frequency is arranged at a closer position to a reference position and a component having a low delivery frequency is arranged at a farther position from the reference position. Changing the component-shelf layout in accordance with the above-described method enables a picking operator to perform the picking operation in a shorter movement distance, so that the efficiency of the picking operation can be improved.

### CITATION LIST

### Patent Literature

Patent Literature 1: Japanese Unexamined Patent Application Publication No. 2011-215715

### SUMMARY OF THE INVENTION

### Problems to be Solved by the Invention

The conventional component-shelf-layout design method, such as Patent Literature 1, focuses only on the traveling movement distance in picking to improve the efficiency of the picking operation. Meanwhile, when component stock on a component shelf has decreased in an actual delivery facility, it is necessary to replenish components to the component shelf in the picking area from a backward storage shelf where components are stored. When the component stock on the component shelf has run out (stockout has occurred), the picking operation is interrupted. Therefore, for improving the efficiency of the picking operation, it is important to perform replenishment to prevent stockout.

In a component replenishment operation, a method is usually used in which when the component stock on the component shelf is below a threshold value (a replenishment point), the components are replenished until the stock amount reaches a preset number of components (a replenishment amount). An occurrence frequency of the replenishment operation is determined by the size of a component shelf to which each component is allocated. For example, as the component shelf for the component is larger, the replenishment amount can be set to be larger. Therefore, more components can be replenished in one replenishment operation, so that the occurrence frequency of the replenishment operation can be lowered. When the occurrence frequency of the replenishment operation is lowered, an occurrence of the stockout caused by delay of the replenishment operation can be suppressed. However, the larger component shelf increases an occupation area of the component shelf in the picking area and therefore the traveling movement distance in the picking is increased. As described above, it is necessary to consider both reduction of the traveling movement distance in the picking and suppression of the occurrence of the replenishment operation in the component-shelf-layout design.

### Solution to the Problem

In order to solve the above problem, the present invention is configured to include a storage unit and a control unit, for example. The storage unit stores picking-operation-results information including information on a delivery amount of each component, component-shelf-distance information including information on a distance between component shelves, and component-shelf-layout information indicating a component shelf, a component allocated to the component shelf, and the capacity of the component shelf. The control unit includes a picking-movement distance calculation unit calculating a picking-movement distance in each component-shelf layout using the information in the storage unit, a replenishment-occurrence frequency calculation unit calculating an occurrence frequency of a replenishment operation using the information in the storage unit, and a new component-shelf layout creation unit creating a plurality of new component-shelf layout proposals and adding them to the component-shelf-layout information. The picking-movement distance calculation unit and the replenishment-occurrence frequency calculation unit calculate the picking-movement distances and the occurrence frequencies of the replenishment operation for a current component-shelf layout and the component-shelf layout proposals created by the new component-shelf layout creation unit. An optimal component-shelf layout extraction unit is further provided that extracts a component-shelf layout proposal satisfying a predetermined condition from the component-shelf layout proposals created by the new component-shelf layout creation unit.

### Advantageous Effects of the Invention

According to the present invention, a user of this device can determine a component-shelf layout that can improve the efficiency of a picking operation and suppress an occurrence of a replenishment operation simultaneously.

### BRIEF DESCRIPTION OF THE DRAWINGS

FIG. 1 is a functional block diagram of a component-shelf-layout design device.

FIG. 2 is a schematic diagram of a component-shelf-layout design system.

FIG. 3 is a schematic diagram showing a picking operation.

FIG. 4 is a schematic diagram of a picking-operation-results information table.

FIG. 5 is a schematic diagram of a component/shelf allocation-availability information table.

FIG. 6 is a schematic diagram of a component-shelf-distance information table.

FIG. 7 is a schematic diagram of a component-shelf-layout information table.

FIG. 8 is a schematic diagram of a component-shelf-layout change information table.

FIG. 9 is a schematic diagram of a picking-operation information table.

FIG. 10 is a schematic diagram of a replenishment-operation information table.

FIG. 11 is a schematic diagram of a parameter information table.

FIG. 12 is a flowchart showing a component-shelf-layout design process.

FIG. 13 is a schematic diagram showing an example of a display screen.

FIG. 14 is a schematic diagram showing an example of the display screen.

### DESCRIPTION OF EMBODIMENTS

Details of an embodiment of the present invention are described below.

FIG. 3 is a schematic diagram showing a picking operation. As shown in FIG. 3, a picking area includes a plurality of component shelves therein, on each of which components are arranged. A picking operator starts from a picking-start point and travels the picking area to collect a plurality of components. Upon completing collecting all the instructed components, the picking operator moves to a picking-end point. When a stock amount on each component shelf is below a replenishment point, a replenishment operator replenishes components from a backward storage shelf to make the stock amount on the component shelf equal to a set replenishment amount. A component-shelf-layout design device according to the present invention is for the above-described operations, for example, and provides a user to a component-shelf-layout change proposal considering both reduction of a picking-movement distance and suppression of occurrence of the replenishment operation.

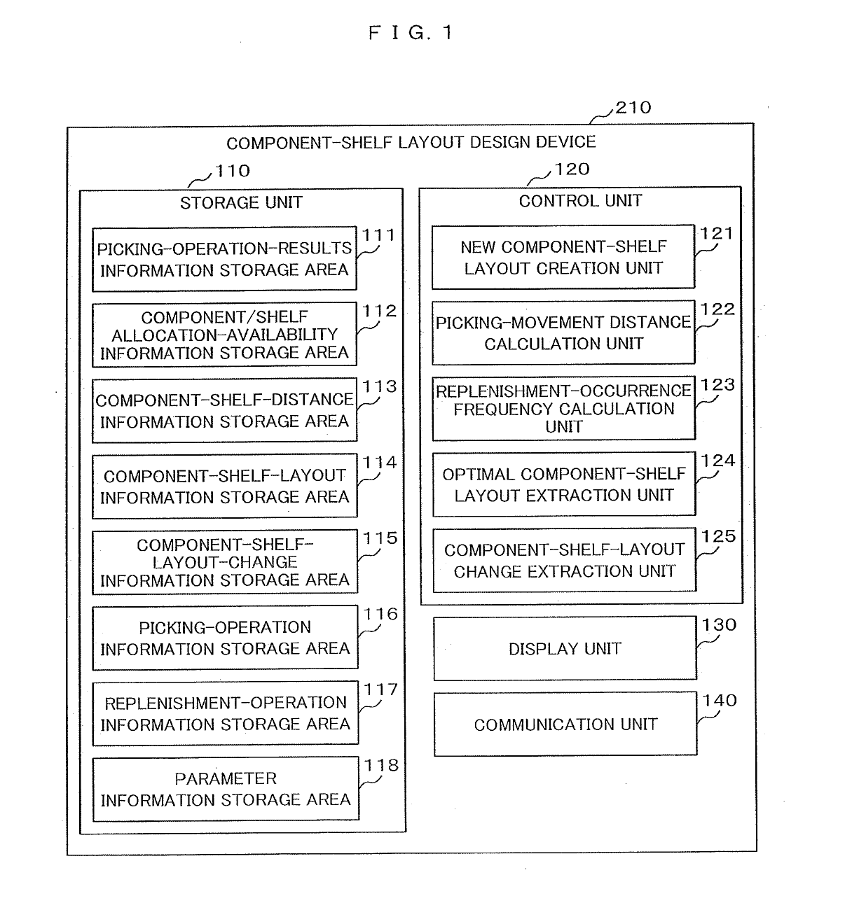

FIG. 1 is a functional block diagram of a component-shelf layout proposal design device. As shown in FIG. 1, the component-shelf layout proposal design device includes a storage unit 110, a control unit 120, a display unit 130, and a communication unit 140.

The storage unit 110 includes a picking-operation-results information storage area 111, a component/shelf allocation-availability information storage area 112, a component-shelf-distance information storage area 113, a component-shelf-layout information storage area 114, a component-shelf-layout change information storage area 115, a picking-operation information storage area 116, a replenishment-operation information storage area 117, and a parameter information storage area 118.

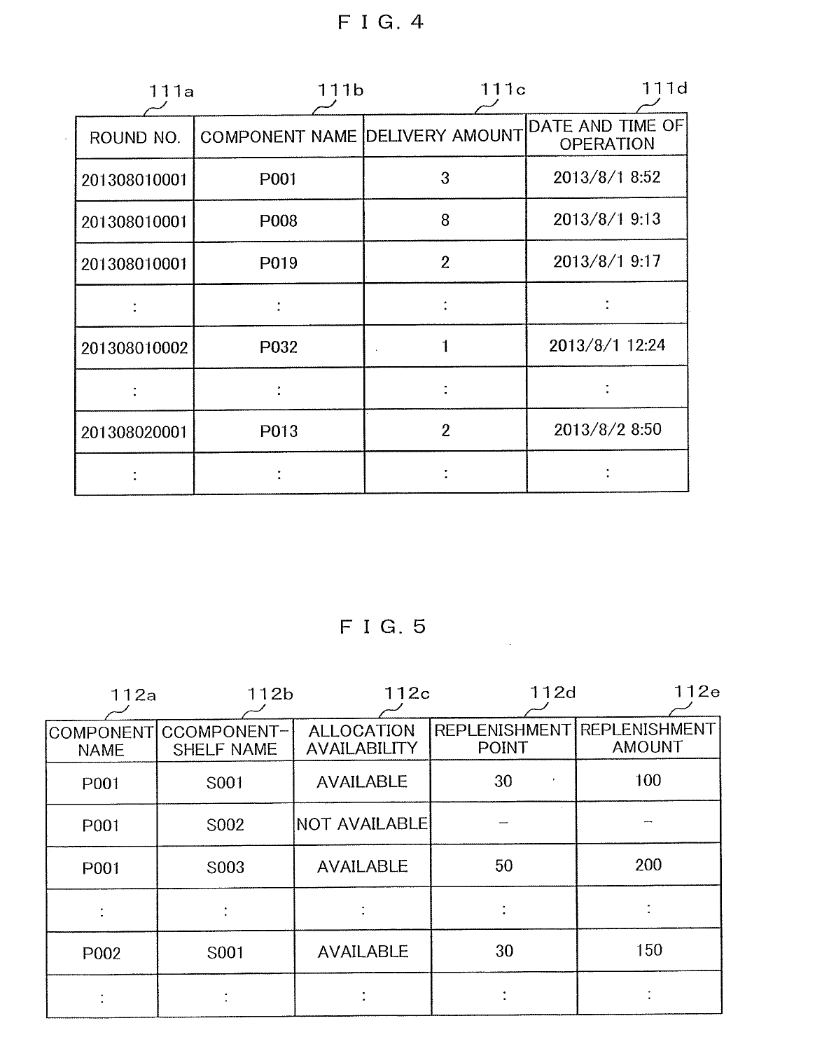

The picking-operation-results information storage area 111 stores information specifying a result of a past picking operation therein. In the present embodiment, for example, a picking-operation-results information table shown in FIG. 4 is stored. As shown in FIG. 4, the picking-operation-results information table has a round-number column 111a, a component-name column 111b, a delivery-amount column 111c, and an operation date-and-time column 111d. The round-number column 111a stores information specifying a round number. A round described here refers to a series of operations starting from the picking-start point, traveling the component shelves to collect all instructed components, and arriving at the picking-end point. The round number is a number uniquely given to the above series of operations. The component-name column 111b stores information specifying a component name. The delivery-amount column 111c stores information specifying the number of corresponding component(s) collected in the corresponding round. The operation date-and-time column 111d stores information specifying an actual date and time of completion of collecting the corresponding component(s) in the corresponding round.

The component/shelf allocation-availability information storage area 112 stores therein information specifying availability of allocation of each component to each component shelf. In the present embodiment, for example, a component/shelf allocation-availability information table shown in FIG. 5 is stored. As shown in FIG. 5, the component/shelf allocation-availability information table includes a component-name column 112a, a shelf-name column 112b, an allocation availability column 112c, a replenishment-point column 112d, and a replenishment-amount column 112e. The component-name column 112a stores information specifying a component name. The shelf-name column 112b stores information specifying a component-shelf name. The allocation availability column 112c stores information specifying whether allocation of the corresponding component to the corresponding component shelf is available. The replenishment-point column 112d and the replenishment-amount column 112e store information specifying the replenishment point and the replenishment amount when the corresponding component is allocated to the corresponding component shelf, respectively. This table can be created based on a component size or various kinds of restrictions in the site. For example, allocation availability can be set to be “NOT AVAILABLE” when the component size is larger than a component-shelf size. The replenishment amount of a component for a component shelf can be calculated from the width, height, and depth of a corrugated cardboard box in which that component is put and the width, height, and depth of that component shelf.

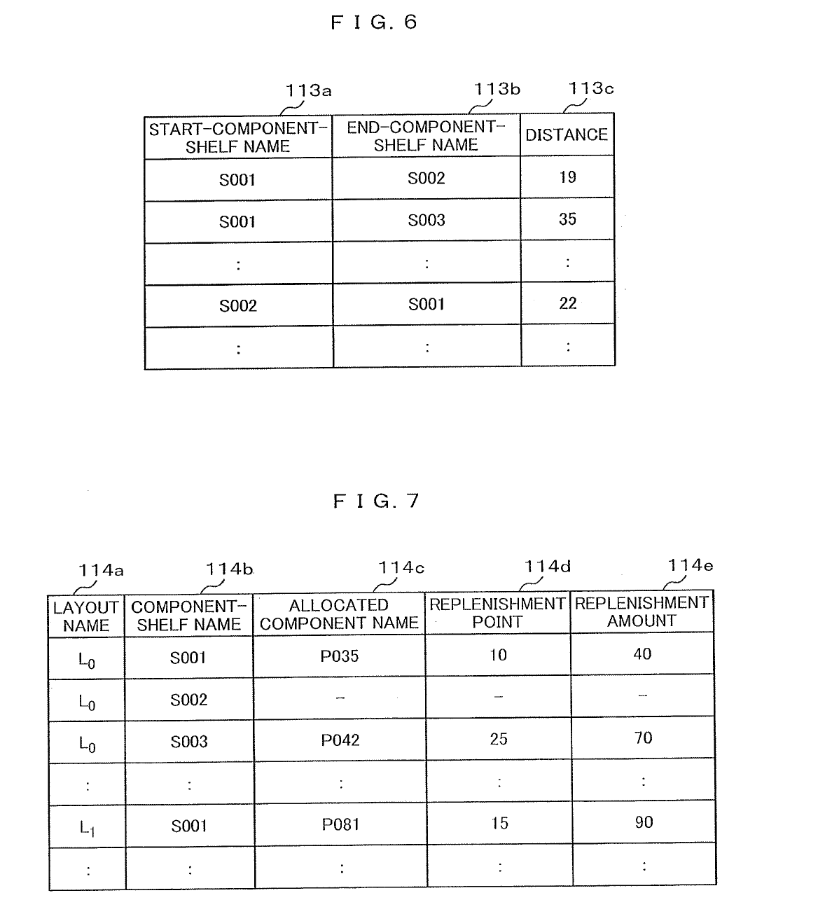

The component-shelf-distance information storage area 113 stores information specifying a distance between a component shelf and another component shelf. In the present embodiment, a component-shelf-distance information table shown in FIG. 6 is stored, for example. As shown in FIG. 6, the component-shelf-distance information table includes a start-point shelf-name column 113a, an end-point shelf-name column 113b, and a distance column 113c. Each of the start-point shelf-name column 113a and the end-point shelf-name column 113b stores information specifying the name of a component shelf. The distance column 113c stores information specifying the distance from the corresponding start-point component shelf to the corresponding end-point component shelf. The distance information stored in the distance column is not necessarily a straight-line distance between the shelves, but is a distance of a moving route in the movement in the picking operation from the corresponding start-point component shelf to the corresponding end-point component shelf. This table also stores information on distances from the start point of the picking operation to each component shelf and from each component shelf to the end point of the picking operation. In the present embodiment, the component-shelf-distance information table is stored assuming that the arrangement of the component shelves is fixed. However, in the case of changing the arrangement of the component shelves, the present invention can be applied by updating the component-shelf-distance information table.

The component-shelf-layout information storage area 114 stores information specifying a component-shelf layout. In the present invention, the component-shelf layout does not describe arranged locations or an arrangement form of the component shelves, but means specifying which component is allocated to each component shelf. For example, a component-shelf-layout information table shown in FIG. 7 is stored in the present embodiment. As shown in FIG. 7, the component-shelf-layout information table includes a layout-name column 114a, a shelf-name column 114b, an allocated-component-name column 114c, a replenishment-point column 114d, and a replenishment-amount column 114e. The layout-name column 114a stores information specifying the name of a component-shelf layout. The shelf-name column 114b stores information specifying a component-shelf name. The allocated-component-name column 114c stores information specifying the name of the component allocated to the corresponding component shelf. The replenishment-point column 114d and the replenishment-amount column 114e are related to the capacity of the component shelf and, when a component is allocated to that component shelf, store information specifying the replenishment point and the replenishment amount of that component on the corresponding component shelf.

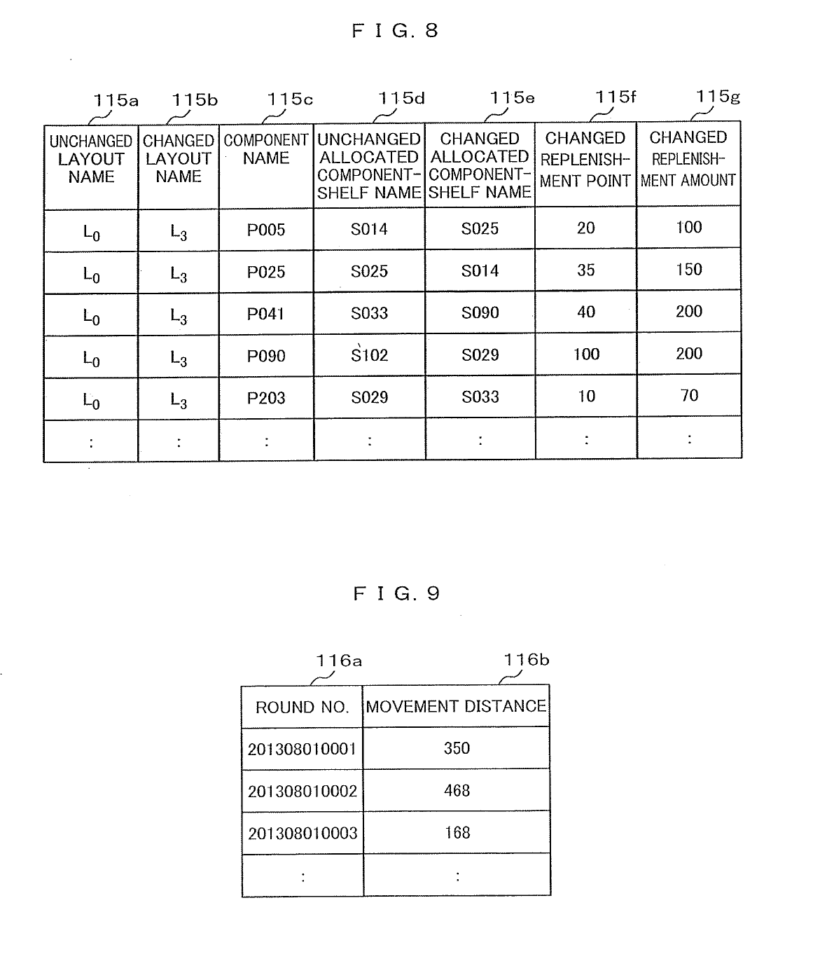

The component-shelf-layout change information storage area 115 stores information specifying a change of component allocation when a layout is changed to another layout, which is a processing result of a component-shelf-layout change extraction unit described later. For example, a component-shelf-layout change information table shown in FIG. 8 is stored in the present embodiment. As shown in FIG. 8, the component-shelf-layout change information table includes a pre-change layout-name column 115a, a changed layout-name column 115b, a component-name column 115c, a pre-changed allocated-shelf-name column 115d, a changed allocated-shelf-name column 115e, a changed replenishment-point column 115f, and a changed replenishment-amount column 115g. The pre-changed layout-name column 115a and the changed layout-name column 115b store information specifying the names of component-shelf layouts before and after being changed. The component-name column 115c stores information specifying a component name. The pre-changed allocated-shelf-name column 115d stores information specifying the name of a component shelf to which the corresponding component is allocated in the corresponding pre-changed layout. The changed allocated-shelf-name column 115e stores information specifying the name of a component shelf to which the corresponding component is allocated in the corresponding changed layout. The changed replenishment-point column 115f and the changed replenishment-amount column 115g store information specifying the replenishment point and the replenishment amount of the corresponding component on the corresponding component shelf in the corresponding changed layout.

The picking-operation information storage area 116 stores information specifying the movement distance of each round in the picking operation, which is a processing result of a picking-movement distance calculation unit described later. For example, a picking-operation information table shown in FIG. 9 is stored in the present embodiment. As shown in FIG. 9, the picking-operation information table includes a round-number column 116a and a movement-distance column 116b. The round-number column 116a stores information specifying a round number. The movement-distance column 116b stores information specifying the movement distance in the corresponding round.

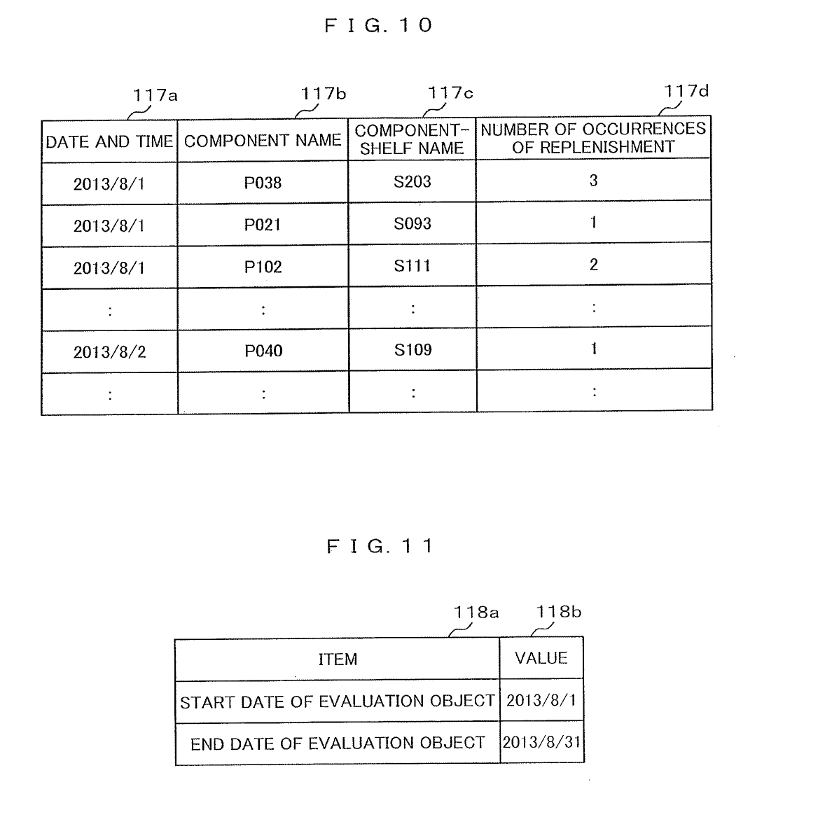

The replenishment-operation information storage area 117 stores information specifying the number of occurrences of a replenishment operation of each component in each day, which is a processing result of a replenishment-occurrence frequency calculation unit described later. For example, a replenishment-operation information table shown in FIG. 10 is stored in the present embodiment. The replenishment-operation information table includes a date column 117a, a component-name column 117b, a shelf-name column 117c, and a number-of-occurrences-of-replenishment column 117d, as shown in FIG. 10. The date column 117a stores information specifying a date. The component-name column 117b stores information specifying a component name. The shelf-name column 117c stores information specifying a component-shelf name. The number-of-occurrences-of-replenishment column 117d stores information specifying the number of occurrences of replenishment of the corresponding component on the corresponding component shelf on the corresponding date.

The parameter information storage area 118 stores information specifying an item and a value of each parameter for which input is received in a display unit described later. For example, a parameter information table shown in FIG. 11 is stored in the present embodiment. As shown in FIG. 11, the parameter information table includes an item column 118a and a value column 118b. The item column 118a stores information specifying a parameter item. The value column 118b stores information specifying a value of that item.

Returning to FIG. 1, the control unit 120 includes a new component-shelf layout creation unit 121, a picking-movement distance calculation unit 122, a replenishment-occurrence frequency calculation unit 123, an optimal component-shelf layout extraction unit 124, and a component-shelf layout change extraction unit 125.

The new component-shelf layout creation unit 121 performs a process that uses the component-shelf-layout information, the component/shelf allocation-availability information, and the component-shelf-distance information in the storage unit 110 to create a new component-shelf layout proposal. In the present embodiment, for example, the new component-shelf layout proposal is created by using current or new component-shelf-layout information and replacing component shelves of any of the two components. Information on the created component-shelf layout proposal is stored in new component-shelf-layout information.

The picking-movement distance calculation unit 122 performs a process that uses the picking-operation-results information, the component-shelf-distance information, and the component-shelf-layout information in the storage unit 110 to calculate a picking-movement distance in each component-shelf layout. The details of this process will be described later.

The replenishment-occurrence frequency calculation unit 123 performs a process that uses the picking-operation-results information and the component-shelf-layout information in the storage unit 110 to calculate an occurrence frequency of the replenishment operation in each component-shelf layout. The details of this processing will be described later.

The optimal component-shelf layout extraction unit 124 performs a process that uses the picking operation information and the replenishment operation information in the storage unit 110 to extract an optical component-shelf layout from the component-shelf layout proposals created by the new component-shelf layout creation unit. The details of this process will be described later.

The component-shelf layout change extraction unit 125 performs a process that uses the component-shelf layout extracted by the optimal component-shelf layout extraction unit 124 to extract a layout change when the current component-shelf layout is changed to an optimal component-shelf layout. The details of this process will be described later.

Returning to FIG. 1, the display unit 130 outputs information in the storage unit 110. For example, the display unit 130 performs a process that displays the information in the component-shelf-layout change information storage area 115 of the storage unit 110. The communication unit 140 performs transmission and reception of information via a network.

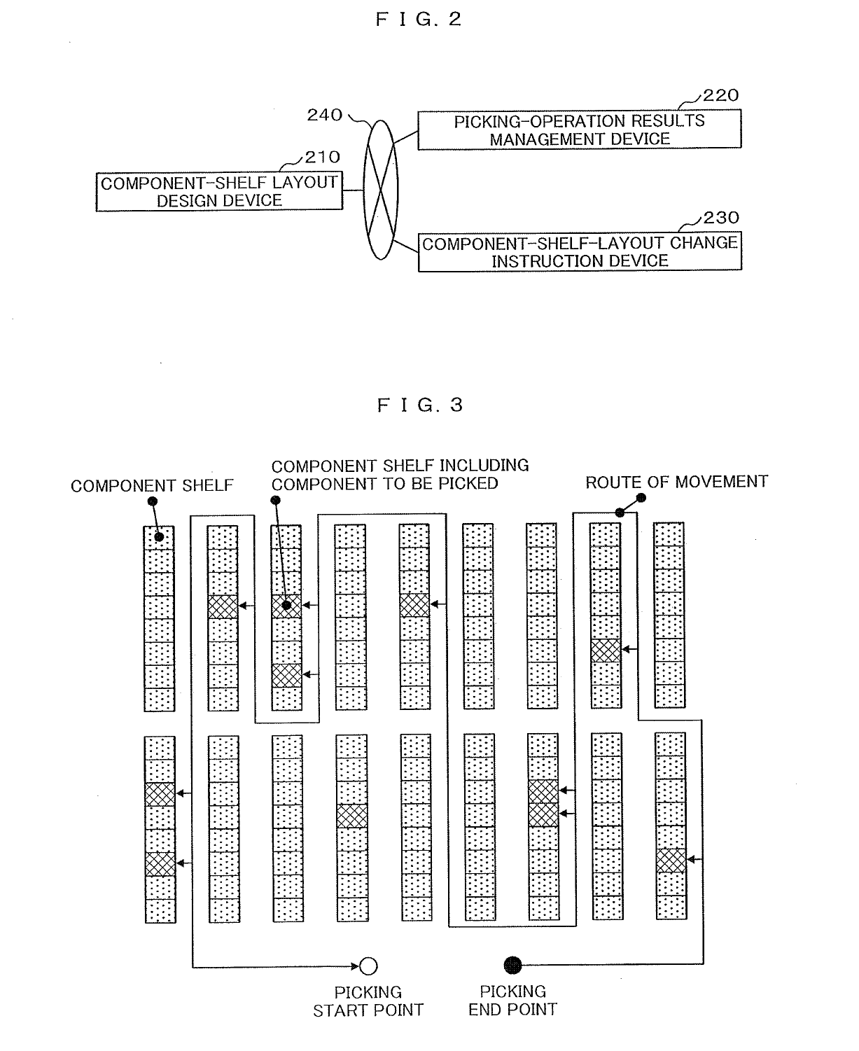

FIG. 2 is a schematic diagram of a component-shelf-layout design system according to an embodiment of the present invention. As shown in FIG. 2, the component-shelf-layout design system includes the component-shelf-layout design device 210, a picking-operation-results management device 220, and a component-shelf-layout change instruction device 230. These devices can transmit/receive information mutually via a network 240.

The picking-operation-results management device 220 receives input from an information terminal used in a picking operation and manages information on the result of the picking operation. Also, the picking-operation-results management device 220 transmits picking-operation-results information to the component-shelf-layout design device 210 at a predetermined time or in response to a request from the component-shelf-layout design device 210. The component-shelf-layout design device 210 stores this information in the picking-operation-results information storage area 111.

The component-shelf-layout change instruction device 230 manages information on an allocation change instruction for each component to each component shelf. The component-shelf-layout change instruction device 230 receives the information in the component-shelf-layout change information storage area 115 from the component-shelf-layout design device 210 at a predetermined time or in response to a request from the component-shelf-layout design device 210.

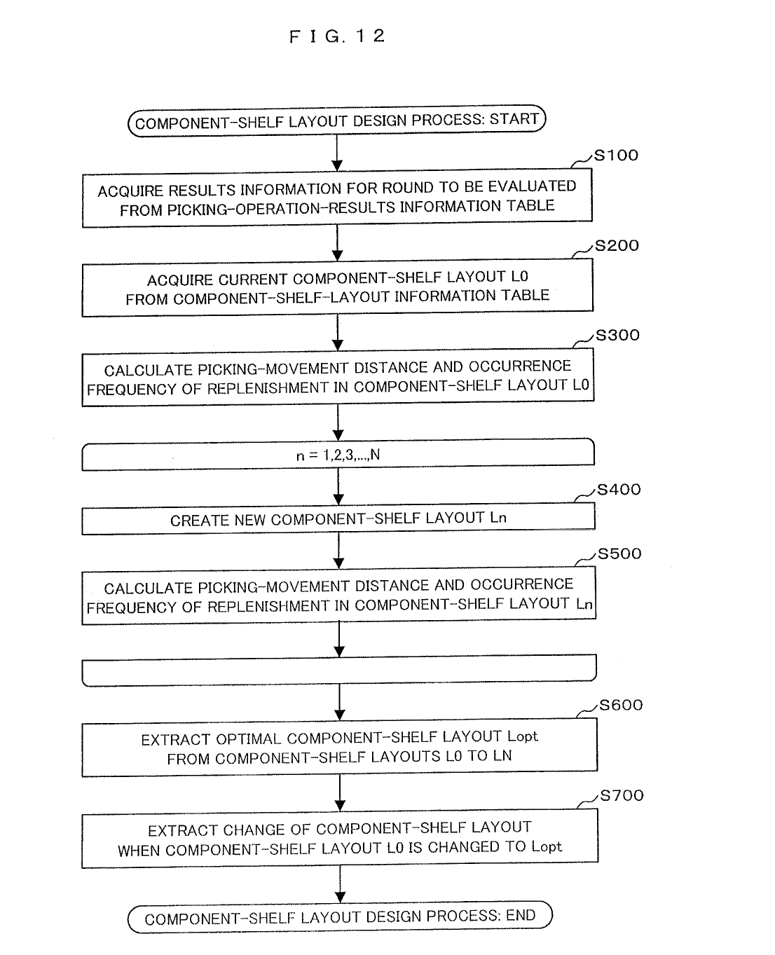

FIG. 12 is an example of a process flowchart of the component-shelf-layout design device. The details of the embodiment of the present invention are described below, referring to FIG. 12.

In Step S100, results information of each round, used for evaluation of a component-shelf layout, is extracted from the picking-operation-results information table in FIG. 4. More specifically, a value of the operation date-and-time column 111d of the picking-operation-results information table in FIG. 4 is extracted as the results information of the round include in a start date and an end date of an evaluated object in the parameter information table in FIG. 11.

In Step S200, a current component-shelf layout L₀ is acquired from the component-shelf-layout information table in FIG. 7.

In Step S300, the picking-movement distance and the replenishment-occurrence frequency are calculated in the component-shelf layout L₀. The process of calculating the picking-movement distance is a process by the picking-movement distance calculation unit 122 of the control unit 120. In calculation of the picking-movement distance, for each round extracted in Step S100, a group of component shelves to be traveled is extracted based on components to be picked in that round and the component-shelf layout L₀ first. Then, the order of traveling the group of component shelves is determined, and the movement distance is calculated from the order of traveling and the component-shelf-distance information. Finally, a calculated value is stored in the picking-operation information table in FIG. 9 as the movement distance of that round. Note that an example of a method that determines the order of traveling the group of component shelves is a method that sequentially selects a shelf to be visited, for example, by visiting Shelf1 as the first component shelf which is the closest component to the picking start point, then visiting Shelf2 which is the closest component shelf to Shelf1, and so on. Another example is a method in which an initial proposal of the visiting order is set and a visiting order that minimizes the movement distance is searched by successively changing the order in the initial proposal. However, the present invention is not limited to the above-described methods.

Calculation of the replenishment-occurrence frequency is a process by the replenishment-occurrence frequency calculation unit 123 of the control unit 120. In the calculation of the replenishment-occurrence frequency, transition of component stock on a component shelf with time is simulated using the delivery amount of each component at each date and time extracted in Step S100. During the simulation, it is assumed that when the component stock is below the replenishment point, the replenishment operation occurs, and the component stock is increased to the replenishment amount. By the above process, the number of occurrences of the replenishment operation is counted. The result of the process is stored in the replenishment-operation information table in FIG. 10.

The processes in Step S400 and S500 are repeated from a value 1 of a counter n to a value N. Step S400 is a process by the new component-shelf layout creation unit 121 of the control unit 120 and creates a new component-shelf layout. More specifically, a component-shelf layout Lₙ is created by changing a portion of the component-shelf layouts L₀ to Lₙ₋₁. The following two methods may be used as a changing method, for example. Either one of them may be used, or both may be applied alternately.

(1) For two components X and Y, component shelves to which they are allocated are replaced with each other, wherein a daily delivery amount is larger for the component X than for the component Y and the replenishment amount is larger for the component Y than for the component X.

(2) For two components X and Y, the component shelves to which they are allocated are replaced with each other, wherein the daily delivery amount is larger for the component X than for the component Y and a distance from the picking start point is smaller for the component Y than for the component X.

Note that the component/shelf allocation-availability information is referred to in the above process, and a restriction is provided to exclude a combination of a component and a component shelf for which allocation is not available. The number of created new component-shelf layouts is determined by predetermining the value for N or predetermining an upper limit of a calculation time. A condition other than the above can be added, for example, in which components simultaneously ordered are arranged at close positions to each other.

In Step S500, the picking-movement distance and the number of occurrences of replenishment are calculated for the component-shelf layout Lₙ created in Step S104. The details of this process are the same as those in Step S300, and therefore the description thereof is omitted.

In Step S600, an optimal component-shelf layout L_{Opt} is extracted from the component-shelf layouts L₀ to L_{N}. Examples of an extraction method are a method that extracts a component-shelf layout minimizing the weighted sum of the picking-movement distance and the number of occurrences of replenishment, a method that extracts a component-shelf layout providing the picking-movement distance equal to or smaller than a threshold value and minimizing the number of occurrences of replenishment, and a method that extracts a component-shelf layout providing the number of occurrences of replenishment equal to or smaller than a threshold value and minimizing the picking-movement distance. A user can set each extracting condition and each threshold value.

In Step S700, a layout change is extracted when the current component-shelf layout L₀ is changed to the optimal component-shelf layout L_{Opt}. This process is a process by the component-shelf-layout change extraction unit 125 of the control unit 120. In this process, a group of components for which allocated component shelves are different between the layouts L₀ and L_{Opt} is extracted, and information on the component-shelf names before and after the layout change for that group of components is stored in the component-shelf-layout change information table.

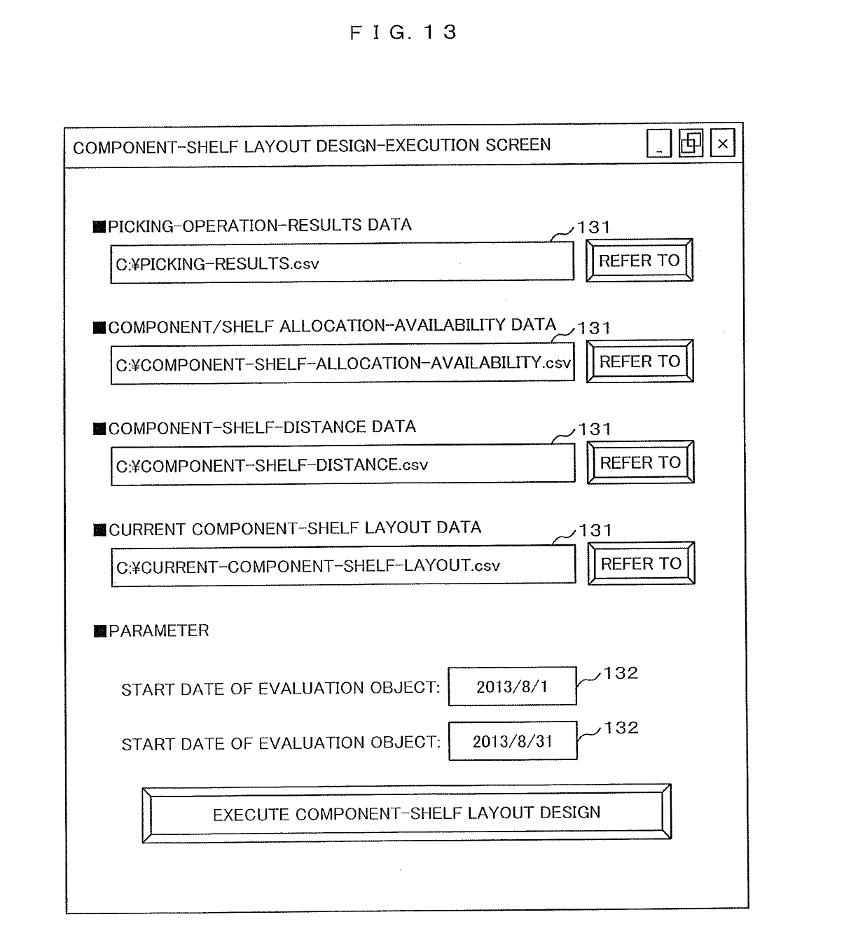

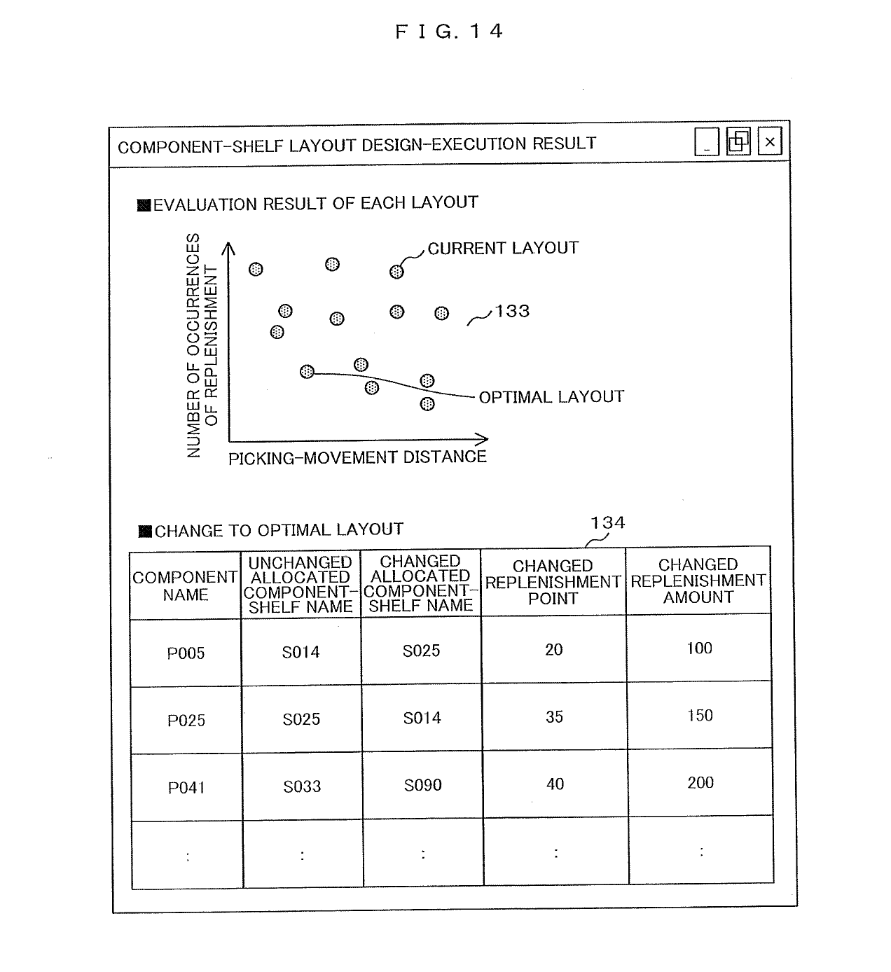

FIGS. 13 and 14 are schematic diagrams of examples of a display screen. FIG. 13 is an input/display screen for setting information to be stored in the storage unit 110. This screen includes data-file-path input/display regions 131 and parameter input/display regions 132. Data created by a user or data stored in an external storage device is imported as picking-operation results data, component/shelf allocation-availability data, component-shelf-distance data, and current component-shelf-layout data. As the picking-operation-results data, not only past results data but also future prediction data can be imported. As the parameter, it is possible to specify a period to be evaluated. The period to be evaluated can be specified by considering a frequency of changing the layout. FIG. 14 is a display screen for displaying the information in the picking-operation information storage area 111, the replenishment-operation information storage area 117, and the component-shelf-layout change storage area 115 in the storage unit 120. This screen includes a layout-evaluation-result display region 133 for displaying an evaluation result of the picking-movement distance and the number of occurrences of replenishment for each layout proposal, and a component-shelf-layout change display region 134 for displaying a changed point in changing the current layout to the optimal layout. Also, when each point on the layout-evaluation-result display screen is selected, this display screen may be configured to display a change for achieving the layout corresponding to that selected point in the component-shelf-layout change display region.

In the present embodiment, evaluation values of the movement distance and the number of occurrences of replenishment in each component-shelf layout proposal are calculated using past picking operation results. However, instead of the past picking operation results, a delivery amount of each product in each future round is predicted and the above evaluation values can be calculated using the prediction result.

In the present embodiment, the picking-movement distance is described as the evaluation value. However, the picking-movement distance calculation unit 122 can convert the picking-movement distance to a picking-operation time by using information on a movement rate of an operator, information on an operation time when the operator picks up each product from each component shelf, and the like. Similarly, as for the number of occurrences of replenishment, the replenishment-occurrence frequency calculation unit 123 can convert the number of occurrences of replenishment to a replenishment-operation time by using information on an operation time required for replenishment of each product onto each product shelf. Then, the optimal component-shelf layout extraction unit 124 can extract the component-shelf layout proposal that can reduce the picking-operation time and the replenishment-operation time as compared with the current component-shelf layout or a component-shelf layout proposal that can minimize the total time.

In addition, each of the configuration, the functions, the control unit, the storage unit described above, for example, can be partly or entirely implemented by hardware by being designed with an integrated circuit, for example. Furthermore, a processor can interpret and execute a program achieving each of the functions, so that the configuration and the functions described above, for example, can be implemented by software. Information such as a program for achieving each function, a table, and a file can be placed in a storage device, such as a memory, a hard disk drive, or an SSD (Solid State Drive), or a storage medium, such as an IC card, an SD card, or a DVD.

1. A component-shelf-layout design device of designing a component-shelf layout specifying a component shelf onto which a component is to be arranged in a manufacturing or delivery facility, comprising:
a storage unit and a control unit, wherein
the storage unit stores picking-operation-results information including information on a delivery amount of each component, component-shelf distance information including information on a distance between component shelves, and component-shelf-layout information indicating a component shelf, a component allocated to the component shelf, and a capacity of the component shelf,
the control unit includes:
a picking-movement distance calculation unit calculating a picking-movement distance in each component-shelf layout using the information in the storage unit;
a replenishment-occurrence frequency calculation unit calculating an occurrence frequency of a replenishment operation using the information in the storage unit;
a new component-shelf layout creation unit creating a plurality of new component-shelf layout proposals and adding the new component-shelf layout proposals to the component-shelf-layout information,
wherein the picking-movement distance calculation unit and the replenishment occurrence frequency calculation unit calculating the picking-movement distances and the occurrence frequencies of the replenishment operation for a current component-shelf layout and the component-shelf layout proposals created by the new component-shelf layout creation unit; and
an optimal component-shelf layout extraction unit extracting a component-shelf layout proposal that satisfies a predetermined condition, from the component-shelf layout proposals created by the new component-shelf layout creation unit.

2. The component-shelf-layout design device according to claim 1, wherein the new component-shelf layout creation unit creates the new component-shelf layout proposals by, for two components X and Y, replacing component shelves to which the two components X and Y are respectively allocated with each other, wherein the delivery amount is larger for the component X than for the component Y and a replenishment amount is larger for the component Y than for the component X.

3. The component-shelf-layout design device according to claim 1, wherein the new component-shelf layout creation unit creates the new component-shelf layout proposals by, for two components X and Y, replacing component shelves to which the two components X and Y are respectively allocated with each other, wherein the delivery amount is larger for the component X than for the component Y and a distance from a picking start point is smaller for the component Y than for the component X.

4. The component-shelf-layout design device according to claim 1, wherein the optimal component-shelf layout extraction unit extracts either one of a component-shelf layout that minimizes a weighted sum of the picking-movement distance and the replenishment occurrence frequency, a component-shelf layout that provides the picking-movement distance equal to or smaller than a threshold value and minimizes the replenishment occurrence frequency, and a component-shelf layout that provides the replenishment occurrence frequency equal to or smaller than a threshold value and minimizes the picking-movement distance.

5. The component-shelf-layout design device according to claim 1, further comprising a component-shelf layout change extraction unit extracting a change of a component shelf and a component allocated thereto when the current component-shelf layout is changed to the component-shelf layout proposal extracted by the optimal component-shelf layout extraction unit.

6. The component-shelf-layout design device according to claim 1, wherein the picking-movement distanced and the replenishment occurrence frequencies that are calculated are output to a display unit for the plurality of new component-shelf layout proposals.

7. The component-shelf-layout design device according to claim 1, wherein
the picking-movement distance calculation unit calculates a picking operation time based on the picking-movement distance, and the replenishment occurrence frequency calculation unit calculates a replenishment operation time based on the occurrence frequency of the replenishment operation, and
the optimal component-shelf layout extraction unit extracts a component-shelf layout proposal that reduces the picking operation time and the replenishment operation time as compared with the current component-shelf layout.

8. A component-shelf-layout design program of designing a component-shelf layout specifying a component shelf onto which a component is to be arranged in a manufacturing or delivery facility, that causes a computer to execute the steps of:
calculating a picking-movement distance in each component-shelf layout using plural information including picking-operation-results information including information on a delivery amount of each component, component-shelf distance information including information on a distance between component shelves, and component-shelf layout information indicating a component shelf, a component allocated to the component shelf, and a capacity of the component shelf;
calculating an occurrence frequency of a replenishment operation by using the plural information;
creating a plurality of new component-shelf layout proposals by using the plural information;
calculating picking-movement distances and occurrence frequencies of the replenishment operation for a current component-shelf layout and the new component-shelf layout proposals by using the plural information; and
extracting a component-shelf layout proposal that satisfies a predetermined condition, from the new component-shelf layout proposals by using the plural information.

9. The component-shelf-layout design program according to claim 8, wherein the step of creating the plurality of new component-shelf layout proposals creates the new component-shelf layout proposals by, for two components X and Y, replacing component shelves to which the two components X and Y are respectively allocated with each other, wherein the delivery amount is larger for the component X than for the component Y and a replenishment amount is larger for the component Y than for the component X.

10. The component-shelf-layout design program according to claim 8, wherein the step of creating the plurality of new component-shelf layout proposals creates the new component-shelf layout proposals by, for two components X and Y, replacing component shelves to which the two components X and Y are respectively allocated with each other, wherein the delivery amount is larger for the component X than for the component Y and a distance from a picking start point is smaller for the component Y than for the component X.

11. The component-shelf-layout design program according to claim 8, wherein the step of extracting the component-shelf layout proposal satisfying the predetermined condition from the new component-shelf layout proposals extracts either one of a component-shelf layout that minimizes a weighted sum of the picking-movement distance and the replenishment occurrence frequency, a component-shelf layout that provides the picking-movement distance equal to or smaller than a threshold value and minimizes the replenishment occurrence frequency, and a component-shelf layout that provides the replenishment occurrence frequency equal to or smaller than a threshold value and minimizes the picking-movement distance.

12. The component-shelf-layout design program according to claim 8, further causing the computer to execute a step of extracting a change of a component shelf and a component allocated thereto when the current component-shelf layout is changed to the extracted component-shelf layout proposal.

13. The component-shelf-layout design program according to claim 8, further causing the computer to execute a step of, for the plurality of new component-shelf layout proposals, outputting the calculated picking-movement distances and the calculated replenishment occurrence frequencies to a display unit.

14. The component-shelf-layout design program according to claim 8, further causing the computer to execute a step of calculating a picking operation time based on the picking-movement distance, calculating a replenishment operation time based on the occurrence frequency of the replenishment operation, and extracting a component-shelf layout proposal that reduces the picking operation time and the replenishment operation time as compared with the current component-shelf layout.
